(19) United States
(12) Patent Application Publication
(10) Pub. No.: US 2004/0167776 A1
(43) Pub. Date: Aug. 26, 2004

(54) Apparatus and method for shaping the speech signal in consideration of its energy distribution characteristics

(76) Inventors: Eun-Kyoung Go, Daejeon-city (KR); Dae-Hwan Hwang, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/656,075

(22) Filed: Sep. 5, 2003

(30) Foreign Application Priority Data
Feb. 26, 2003 (KR) 2003-11973

(51) Int. Cl. G10L 19/06; G10L 11/06

(52) U.S. Cl. 704/208; 704/209

(57) ABSTRACT

An apparatus and method for shaping the speech signal in consideration of its energy distribution. The shaping apparatus includes an encoder for receiving and encoding an unvoiced speech or background noise, dividing it into frequency bands according to its characteristics, performing comparison of energies of the frequency bands, and setting energy intensity flags according to the comparison result; and a decoder for shaping the data encoded by the encoder and the energy intensity flags. The present invention employs the shaping method in consideration of characteristics of the original input speech signal, and uses the shaping filter only using information about energy distribution without adding a large amount of bits to the signal that is difficult to synthesize, such as an unvoiced speech and background noise.

### CROSS REFERENCE TO RELATED APPLICATION

This application claims priority to and the benefit of Korea Patent Application No. 2003-11973 filed on Feb. 26, 2003 in the Korean Intellectual Property Office, the content of which is incorporated herein by reference.

### BACKGROUND OF THE INVENTION

(a) Field of the Invention

The present invention relates to an apparatus and method for shaping the speech signal to shape its spectrum characteristics. More specifically, the present invention relates to an apparatus and method for shaping the speech signal in consideration of its energy distribution in order to restore the majority of characteristics of the signal.

(b) Description of the Related Art

In the present invention, “shaping” is a method of restoring spectrum characteristics of an original input speech signal during a decoding process in the case that the input signal includes an unvoiced speech and background noise, in the speech CODEC technique.

In general, a shaping method used in the speech CODEC is applied to encoder and decoder algorithms. This shaping method has an input limited to an unvoiced speech and background noise, and it utilizes a CELP (Code Excited Linear Prediction) CODEC having a low bit rate.

FIG. 1 is a block diagram showing a configuration of a shaping apparatus of a conventional speech CODEC. Referring to FIG. 1, the conventional shaping apparatus includes a random number vector part 110, a random number generator 120, a gain part 130, an adder 140, and a shaping unit 150.

In the conventional shaping method, a gain value, which is obtained using index information about a gain quantized for an input speech signal from an encoder to the gain part 130, and a random number, which is generated by the random number generator 120 from an input signal e(n) from the random number vector part 110, are added with the adder 140 and then shaped. That is, shaping detects an excited component r(n) of a signal using the random number and a linear prediction coefficient. This excited component r(n) passes through a high pass filter that filters very low frequency components, and is then shaped irrespective of its frequency band. Here, the signal r(n), which is a signal obtained from the signal e(n) of the random number vector part 110 and the quantized gain value, means an actually shaped signal.

The aforementioned conventional shaping technique shapes the input signal without respect to its characteristics so that the quantity of calculations is increased. Furthermore, the characteristics of the input signal of the current frame cannot be maximized, although the entire spectrum can be shaped.

To detect the speech section in a voice recognition system, Korean Patent No. 10-1997-00760307, entitled “A method for detecting the speech section in a voice recognition system” proposed a technique that compares energies of frequency bands of an input speech signal to detect the speech section more accurately. This patent emphasizes the high-frequency band of the input signal using a high pass filter, divides the input signal having the emphasized high-frequency band into frames each of which has a predetermined size using a hamming window, and carries out Fast Fourier Transform (FFT) for each of the divided frames, to obtain energy corresponding to each frequency. Then, it acquires correlation of energies of the frequency bands of the input signal, calculates a decision index of the speech section to compare it with a threshold, and distinguishes the speech signal from a noise signal, to detect the speech section. However, this technique is used for detecting the speech section and not used for shaping the spectrum of the speech signal in the event of coding the speech signal.

### SUMMARY OF THE INVENTION

It is an advantage of the present invention to provide an apparatus and method for shaping the speech signal in consideration of its energy distribution, which shapes the original speech signal without having any change in its energy distribution characteristics to emphasize the spectrum of the frequency band having lots of signal components so as to improve speech quality of the speech CODEC.

In one aspect of the present invention, the shaping apparatus in consideration of energy distribution of the speech signal includes an encoder that performs pre-processing and FFT for an input speech signal corresponding to an unvoiced speech or background noise, and carries out comparison of energies of frequency bands divided according to characteristics of unvoiced speech or background noise, to detect band flags representing energy distribution characteristics according to the comparison result; and a decoder for shaping the speech signal in consideration of the frequency band characteristics of the original input speech signal sent from the encoder.

Desirably, energy intensity flags set by an unvoiced speech energy comparator or background noise energy comparator of the encoder comprise a maximum energy flag (Maxflag) set to the band having the maximum energy among the plurality of bands; a minimum energy flag (Minflag) set to the band having the minimum energy among the plurality of bands; and an energy flag (Maxflag=4) set when energy is uniformly distributed for the plurality of bands.

Desirably, the decoder comprises a quantized gain information part having quantized gain information of the input signal; a random number vector part outputting a signal that is added to the quantized gain information from the quantized gain information part for the purpose of shaping the input signal; a filter selector for distinguishing the input signal into the unvoiced speech and background noise and selecting a filter corresponding to each of the unvoiced speech and background noise; and a shaping unit for differentially shaping the signal, obtained by adding the signal from the quantized gain information part to the signal from the random number vector part, and a input speech signal through the filter selector according to the energy comparison result obtained by the encoder.

In another aspect of the present invention, the method for shaping the speech signal in consideration of its energy distribution characteristics, comprises a step (a) of Fourier-transforming the speech signal to obtain energy in its frequency domain; a step (b) of judging whether the Fourier-transformed speech signal is an unvoiced speech or background noise, dividing it into a plurality of frequency bands according to its frequency, and comparing energies of the divided bands; and a step (c) of setting energy intensity flags using the comparison result, and shaping the speech signal according to its characteristics.

Desirably, the step (b) compares the energies of the frequency bands, differently divided according to whether the input speech signal is the unvoiced speech or background noise, to determine the band having the maximum energy, the band having the minimum energy, and whether the energies are uniformly distributed.

In the case that the input speech signal is the unvoiced speech in the step (c), Desirably, the shaping method further comprises the steps of comparing the energies of the plurality of bands and shaping the speech signal excepting the band having the maximum energy and the band having the minimum energy; and shaping the band with the maximum energy.

In the case that the input speech signal is the background noise in the step (c), preferably, the shaping method further comprises the steps of comparing the energies of the frequency bands using a plurality of band signals other than the first band in which the background noise is largely distributed; shaping the first band; and, in the case that there is a band having greater energy than the first band from the comparison result, shaping that band.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram showing a configuration of a shaping apparatus of a conventional speech CODEC;

FIG. 2 is a block diagram showing a configuration of a shaping apparatus in consideration of energy distribution characteristics of the speech signal according to an embodiment of the present invention;

FIG. 3 is a block diagram showing a configuration of the decoder shown in FIG. 2 according to an embodiment of the present invention;

FIG. 4 shows a division of frequency bands of an unvoiced speech and background noise according to an embodiment of the present invention;

FIG. 5 shows shaping filter characteristics of an unvoiced speech according to an embodiment of the present invention;

FIG. 6 shows shaping filter characteristics of background noise according to an embodiment of the present invention;

FIG. 7 shows frequency characteristics of a general unvoiced speech /t/; and 20 FIG. 8 shows frequency characteristics of a general unvoiced speech /sh/.

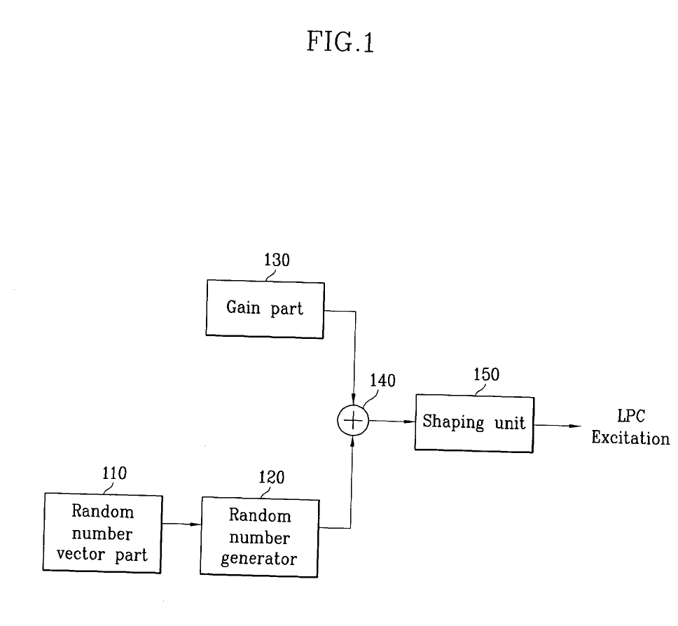

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

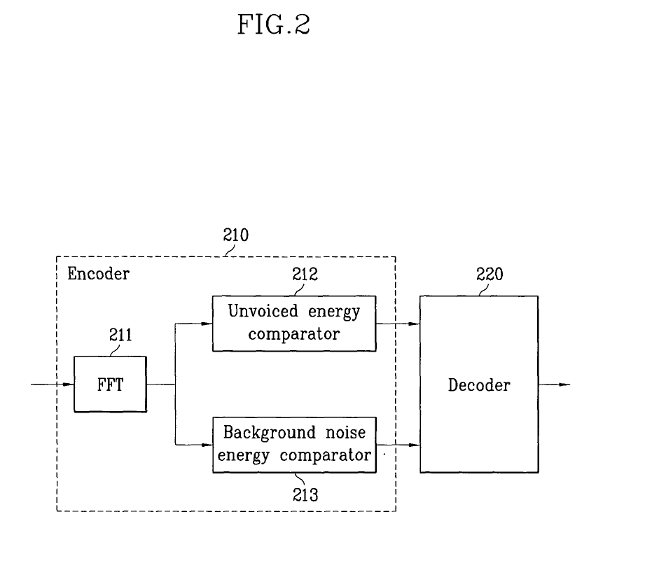

FIG. 2 is a block diagram showing a configuration of an apparatus for shaping the speech signal in consideration of its energy distribution characteristics according to an embodiment of the present invention. Referring to FIG. 2, the shaping apparatus includes an encoder 210 and a decoder 220. The encoder 210 consists of a FFT unit 211, an unvoiced energy comparator 212, and a background noise energy comparator 213.

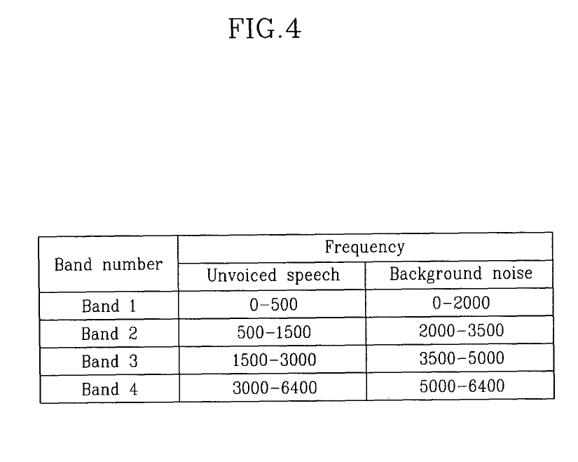

Specifically, the FFT unit 211 receives the speech signal and obtains energy of the signal in the frequency domain. The unvoiced comparator 212 divides an unvoiced speech included in the speech signal into four different frequency bands and performs comparison of energies of the bands. The background noise energy comparator 213 splits background noise into four different frequency bands and compares energies of the bands. FIG. 4 shows an example of divided frequency bands of the unvoiced speech and background noise. When the input speech signal is unvoiced speech or background noise to the shaping apparatus, the energies respectively corresponding to the frequency bands, divided as shown in FIG. 4, are compared.

According to the comparison results obtained from the unvoiced energy comparator 212 and background noise energy comparator 213, a maximum energy flag Maxflag is set to the maximum energy, and a minimum energy flag Minflag is set to the minimum energy. When the energies of the four bands are uniform, the energy flag Maxflag is set to 4. Then, the flags are applied to the decoder 220.

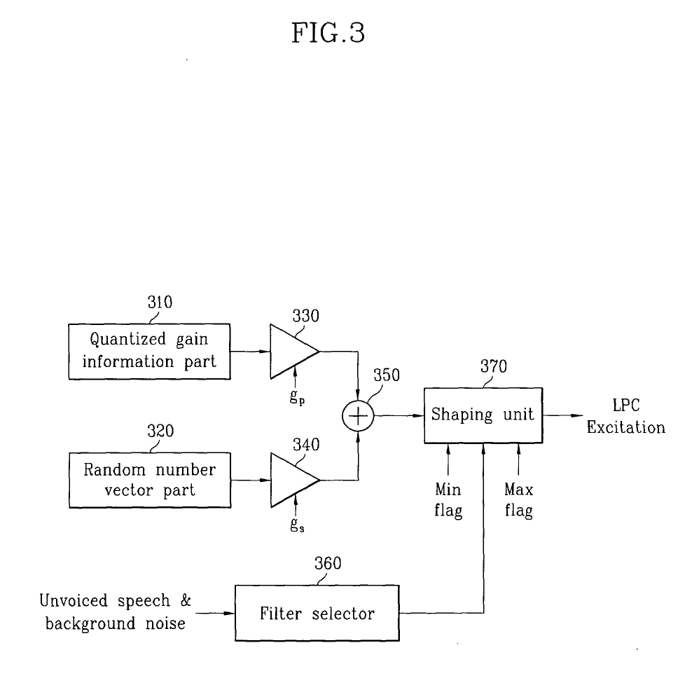

FIG. 3 is a block diagram showing a configuration of the decoder 220. Referring to FIG. 3, the decoder 220 includes a quantized gain information part 310, a random number vector part 320, operational amplifiers 330 and 340, an adder 350, a filter selector 360, and a shaping unit 370.

The decoder 220 according to an embodiment of the present invention has a random number vector part 320 and adder 350 identical to those of the conventional shaping apparatus. The quantized gain information part 310 has quantized gain information, and the filter selector 360 selects a filter depending on characteristics of an unvoiced speech or noise according to whether the current frame is an unvoiced speech or background noise on the basis of information delivered from the encoder 210. The shaping unit 370 performs shaping using the minimum energy flag Minflag and maximum energy flag Maxflag sent from the encoder 210.

A shaping method in the apparatus for shaping the speech signal in consideration of its energy distribution according to the invention, constructed as above, is explained in detail.

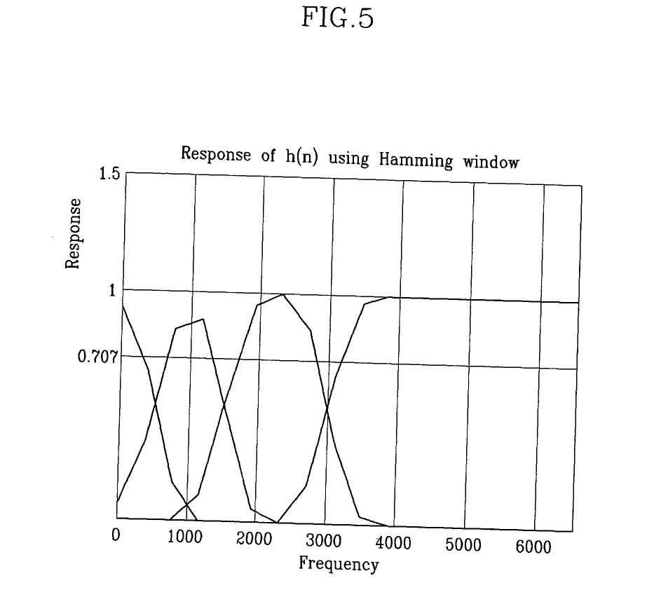

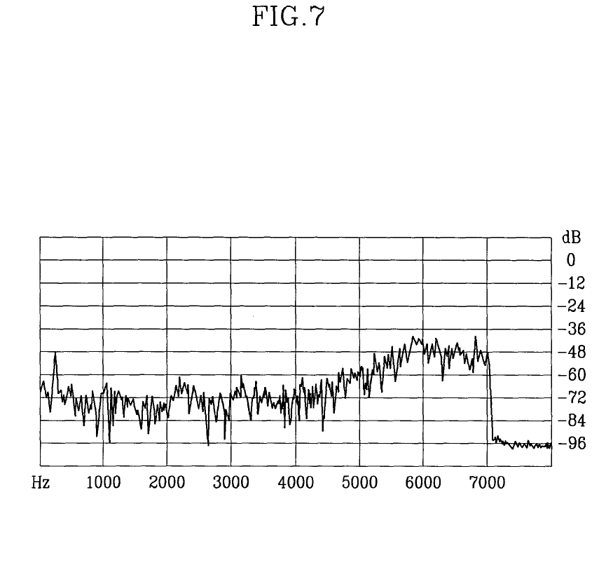

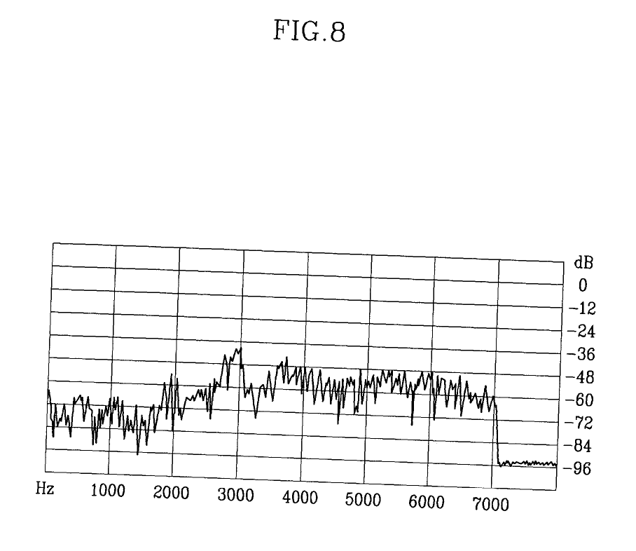

When the speech signal S(n) is inputted to the encoder 210, the FFT unit 211 of the encoder 210 carries out FFT of 128 pointers, to obtain energy of the input signal in the frequency domain. The unvoiced energy comparator 212 and background noise energy comparator 213 respectively divide an unvoiced speech and background noise, included in the speech signal, into four different frequency bands, as shown in FIG. 4, and compare energies of the bands. In case of the unvoiced speech, the unvoiced energy comparator 212 shows the following frequency characteristics according to the feature of the vocal tract model. FIG. 5 shows shaping filter characteristics of an unvoiced speech according to an embodiment of the present invention, FIG. 7 shows frequency characteristics of a general unvoiced speech /t/, and FIG. 8 shows frequency characteristics of a general unvoiced speech /sh/.

Referring to FIG. 5, the unvoiced energy comparator 212 sets the maximum energy flag Maxflag to the maximum energy, and sets the minimum energy flag Minflag to the minimum energy. In addition, it sets Maxflag to 4 when the energies of the four different bands are distributed uniformly.

That is, in the case that the input signal is an unvoiced speech, three bands other than the minimum energy flag Minflag are shaped, and then the maximum energy flag Maxflag corresponding to the maximum energy is shaped one more time. Here, if Maxflag is 4, shaping is sequentially carried out for the entire bands because energy is uniformly distributed in the current frame. In this case, a difference between the maximum and minimum values of the energies of the four bands is calculated to obtain a threshold value for judging the case of uniform energy.

The threshold value is decided by investigating the distribution of the difference between the maximum and minimum values of the energies. It is judged that the energies are uniformly distributed when the difference between the maximum and minimum values is lower than the threshold value. In this case, when one frequency band is shaped one-sidedly, shaping is carried out for wrong bands. Thus, it is possible to synthesize a wrong signal component compared to the original signal. This is because, in the case that a signal passes through a filter with divided bands, frequency division occurs near the threshold value of the filter. To remove this frequency division, the order of the filter is increased so as to design a filter with smoother characteristics, or a filter factor of a frequency band is interpolated.

The method of raising the order of the filter brings about an increase in the filter factor to result in a large amount of calculations. Accordingly, the present invention uses the method of interpolating the filter factor of the frequency band to be shaped so as to eliminate the frequency division phenomenon while having the shaping effect.

The unvoiced speech /t/ and /sh/ show the frequency characteristics as illustrated in FIGS. 7 and 8, respectively.

In the meantime, the background noise energy comparator 213 has the following characteristics.

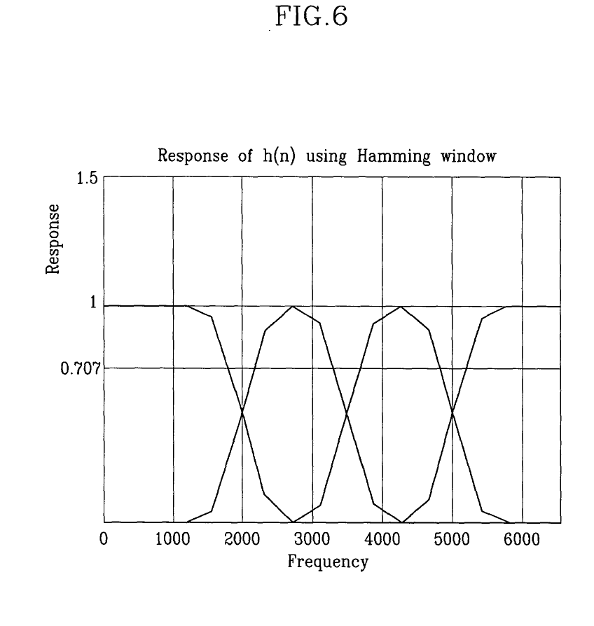

FIG. 6 shows shaping filter characteristics of background noise according to an embodiment of the present invention. Referring to FIG. 6, when the input signal is background noise, it can be confirmed that energies are largely distributed in low frequency bands rather than high frequency bands. Energy distribution for background noise components variously caused such as by vehicles, and office and street noises, is grasped such that energy is largely distributed below 2 KHz. Accordingly, in the case that a background noise signal is applied to the shaping apparatus as an input signal, shaping is performed for bands of 0˜2 KHz at all times and energy comparison is carried out for other bands. Here, if there is a band having greater energy than the first band, it is possible to shape the background noise signal.

The present invention employs a 16-order band pass filter as the shaping filter. The name of the filter is designated as UV in the case of unvoiced speech and BN in the case of background noise. The shaping method is explained below.

First of all, the unvoiced speech and background noise are defined as follows.

UV(z)=1+UV_{d1}z⁻¹+. . . +UV_{d15}z⁻¹⁵ (1)

BN(z)=1+BN_{d1}z⁻¹+. . . +BN_{d15}z⁻¹⁵ (2)

The unvoiced speech or background noise represented by the equation (1) or (2) can be shaped as follows.

UN(z)=UV(z)·UV(z)·UV(z)·UV_{Max}(z) (3)

The equation (3) represents the case that the unvoiced speech is shaped. Here, the shaping filter shapes the unvoiced speech other than the band having the minimum energy. Thus, the band having the minimum value is excluded.

BN(z)=BN₁ₛₜ(z)·BN_{Max}(z) (4)

The equation (4) represents shaping the background noise. Here, the first band and the band having the maximum energy are shaped.

As described above, the present invention employs the shaping method in consideration of characteristics of the original signal in the case that an input signal inputted to a CELP speech CODEC is an unvoiced speech or background noise, to improve speech quality of the speech CODEC. The present invention uses the shaping filter only using information about energy distribution without adding a large amount of bits to the signal that is difficult to synthesize, such as an unvoiced speech and background noise, so that quality of the speech CODEC and bit rate can be improved.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An apparatus for shaping the speech signal in consideration of its energy distribution characteristics, comprising:
an encoder for receiving and encoding an unvoiced speech or background noise, dividing it into a plurality of frequency bands according to its characteristics, performing comparison of energies of the frequency bands, and setting energy intensity flags according to the comparison result; and
a decoder for shaping the data encoded by the encoder and the energy intensity flags.

2. The shaping apparatus as claimed in claim 1, wherein the encoder comprises:
an FFT unit for receiving the speech signal corresponding to an unvoiced speech or background noise and Fourier-transforming it, to obtain energy in the frequency domain of the speech signal;
an unvoiced energy comparator for, when the speech signal transformed by the FFT unit is the unvoiced speech, dividing the unvoiced speech into a plurality of frequency bands according to its energy distribution, carrying out comparison of energies of the bands, and setting energy intensity flags according to the comparison result; and
a background noise energy comparator for, when the speech signal transformed by the FFT unit is the background noise, dividing the background noise into a plurality of frequency bands according to its energy distribution, carrying out comparison of energies of the bands, and setting energy intensity flags according to the comparison result.

3. The shaping apparatus as claimed in claim 2, wherein the energy intensity flags set by the unvoiced energy comparator or background noise energy comparator comprise:
a maximum energy flag (Maxflag) set to the band having the maximum energy among the plurality of bands;
a minimum energy flag (Minflag) set to the band having the minimum energy among the plurality of bands; and
an energy flag (Maxflag=4) set when energy is uniformly distributed for the plurality of bands.

4. The shaping apparatus as claimed in claim 1, wherein the decoder comprises:
a quantized gain information part having quantized gain information of the input signal;
a random number vector part outputting a signal that is added to the quantized gain information from the quantized gain information part for the purpose of shaping the input signal;
a filter selector for distinguishing the input signal into the unvoiced speech and background noise, and selecting a filter corresponding to each of the unvoiced speech and background noise; and
a shaping unit for differentially shaping the signal, obtained by adding the signal from the quantized gain information part to the signal from the random number vector part, and the input speech signal through the filter selector according to the energy comparison result obtained by the encoder.

5. A method for shaping the speech signal on the unvoiced speech or background noise in consideration of its energy distribution characteristics, comprising:
(a) Fourier-transforming the speech signal to obtain energy in its frequency domain;
(b) determining whether the Fourier-transformed speech signal is an unvoiced speech or background noise, dividing it into a plurality of frequency bands according to its frequency, and comparing energies of the divided bands; and
(c) setting energy intensity flags using the comparison result, and shaping the speech signal according to its characteristics.

6. The shaping method as claimed in claim 5, wherein (b) comprises: comparing the energies of the frequency bands, differently divided according to whether the input speech signal is the unvoiced speech or background noise, to find the band having the maximum energy, the band having the minimum energy, and whether the energies are uniformly distributed.

7. The shaping method as claimed in claim 5, in the case that the input speech signal is the unvoiced speech in (c), further comprising:
comparing the energies of the plurality of bands and shaping the speech signal excepting the band having the maximum energy and the band having the minimum energy; and
shaping the band with the maximum energy.

8. The shaping method as claimed in claim 5, in the case that the input speech signal is the background noise in (c), further comprising:
grasping the energy distribution for the component of the background noise, and comparing the energies of the frequency bands using a plurality of band signals other than the first band having a frequency at which the background noise is largely distributed;
shaping the first band; and
shaping that band when there is a band having greater energy than the first band from the comparison result.

9. The shaping method as claimed in claim 7, wherein interpolation is carried out for shaped bands with a filter factor divided into a plurality of bands for the purpose of removing frequency division that may occur during the shaping operation.

10. The shaping method as claimed in claim 8, wherein interpolation is carried out for shaped bands with a filter factor divided into a plurality of bands for the purpose of removing frequency division that may occur during the shaping operation.
